(19) United States
(12) Patent Application Publication
(10) Pub. No.: US 2004/0179637 A1
(43) Pub. Date: Sep. 16, 2004

(54) Method of adaptive signal processing for diversity signals

(76) Inventor: Charles Bert Hickman, Palmdale, CA (US)

Correspondence Address: CHARLES BERT HICKMAN, 3817 SOUTHVIEW COURT, PALMDALE, CA, 93550, US

(21) Appl. No.: 10/385,362

(22) Filed: Mar. 11, 2003

(51) Int. Cl. H04B 15/00; H04L 1/02

(52) U.S. Cl. 375/347; 375/285; 714/746

(57) ABSTRACT

An improved method of the adaptive signal processing for diversity signals is disclosed. Under normal adaptive signal processing conditions a plurality of input diversity signals would tend to cause undesirable coefficient interactions. By employing a plurality of diversity related errors the present invention tends to ameliorate these undesirable coefficient interactions.

### BACKGROUND OF THE INVENTION

This patent relates to adaptive signal processing. If the signal stream within an adaptive signal processor is correlated from delay tap to delay tap then the tap coefficient weights tend to interact; this cause one correlated tap to go more positive while the other tends to go more negative. Even though this situation may statistically null out, the noise within an instantaneous signal estimate can be greatly exacerbated by this condition. Under this condition, usually amelioration techniques such as “bleeds” to the coefficient weights are employed.

In general adaptive processors function better if the signal within the processing pipeline has a very low degree of autocorrelation over the total processing time. This means that for data communications it is desirable to use a PN scrambler in order to reduce the autocorrelation that may occur from time-to-time in the data stream. Also, for repetitive patterns such as coronary heartbeat, it is desirable for the processing time to be less than the repetition rate of the heartbeat.

FIG. 1 depicts the general topology for a standard adaptive signal processor with diversity signal inputs (derived from “Adaptive Signal Processing” FIG. 1.4, by Bernard Widrow and Samuel D. Stearns, Prentice-Hall Inc., 1985). The first diversity input signal 105 is sent to PROC1 110 which produces partial estimate signal 125 output. The second diversity input signal 115 is sent to PROC1 120 which produces partial estimate signal 135 output. These partial estimate signals 125 and 135 are added together within summer 130 to produce estimate signal 145 output. Estimate signal 145 is subtracted from the desired signal 155 within the summer 140 to produce an error signal 165 output. Error signal 165 is sent to ADAPT 150 wherein an adaptation algorithm such as the LMS algorithm is applied to the error signal 165 to produce adjustment group signals 175. These adjustment group signals 175 are applied to PROC1 110 and PROC2 120 for coefficient weight adjustments. This method tend to have undesired interactions between PROC1 110 and PROC2 120 coefficients.

For various military and commercial applications (e.g. troposcatter communications) signal diversities are employed. These diversities may be frequency, spatial, temporal, or combinations thereof (Herein, an example of temporal diversity could be where the adaptive signal processor has tap delays at fractional spacing of data timing period.) These diversity signals when present within the same adaptive signal processor are highly correlated and tend to cause the undesired tap coefficient interactions as explained above. The present invention addresses this problem of coefficient interaction.

### BRIEF SUMMARY OF THE INVENTION

The present invention takes a plurality of diversity signal inputs to produce a desired output as in normal adaptive signal processing. However, it does not producing only one error signal which would cause diversity coefficient interactions because of the high degree of correlation between the diversity signals. The present invention employs a corresponding set of diversity related error signals that ameliorates the interactions between the diversity processing coefficients.

### BRIEF DESCRIPTION OF THE DRAWINGS

FIG. 1 depicts a customary (prior art) adaptive signal processor for diversity signals that has only one error signal.

FIG. 2 depicts the present invention that produces a plurality of error signals for adaptive signal processing for diversity signals.

FIG. 3 depicts the present invention that produces a plurality of error signals for decision directed adaptive signal processing for diversity signals.

### DETAILED DESCRIPTION OF THE INVENTION

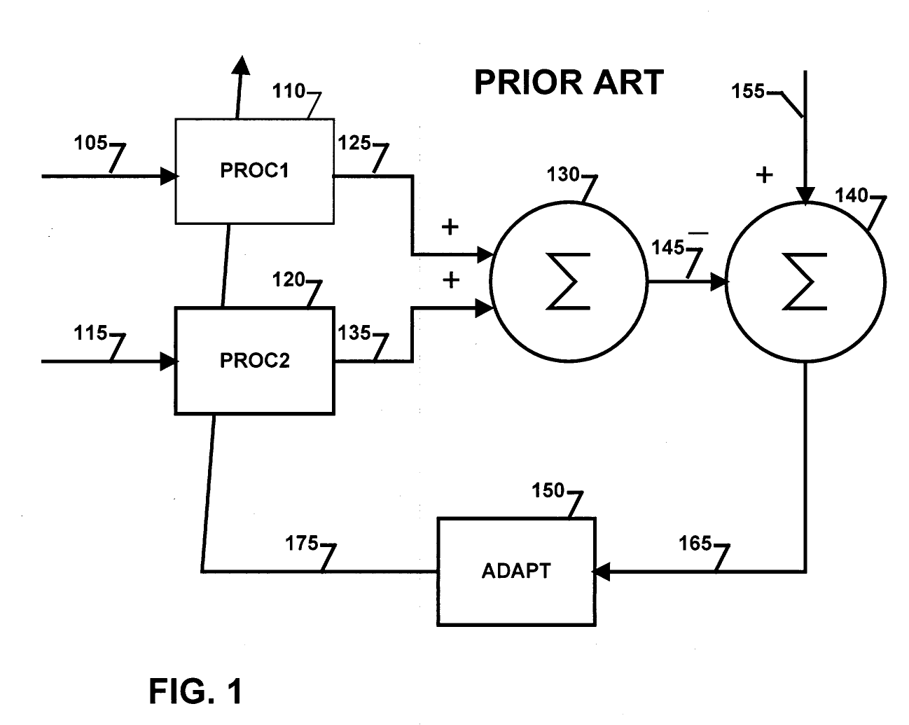

An improved method for the adaptive signal processing for diversity signals is disclosed. In the following description for purposes of explanation, numerous details are set forward to provide a through understanding of the present invention. However, it will be apparent to one ordinarily skilled in the art that these details are not required in order to practice the invention. It should be noted that the present invention is an understandable variation of Widrow's FIG. 1.4 (“Adaptive Signal Processing” as above) with more specifics in FIG. 1.5, plus detailed examples and explanations throughout; therefore, it should be apparent to one ordinarily skilled in the art as to how the present invention can be implemented. Thus extensive details related to adaptive signal processing are not presented herein, because adequate literature exists for that purpose. Also, it should be noted, for digital diversity signals simple examples are given; however, that does not preclude the application of the present invention to more complex modulated signals (e.g. m-ary signals). Herein, adaptive signal processing for only two diversity signals are given for illustrations; this should in no way be construed as to place a limit upon the number of the plurality of diversity signals to be processed.

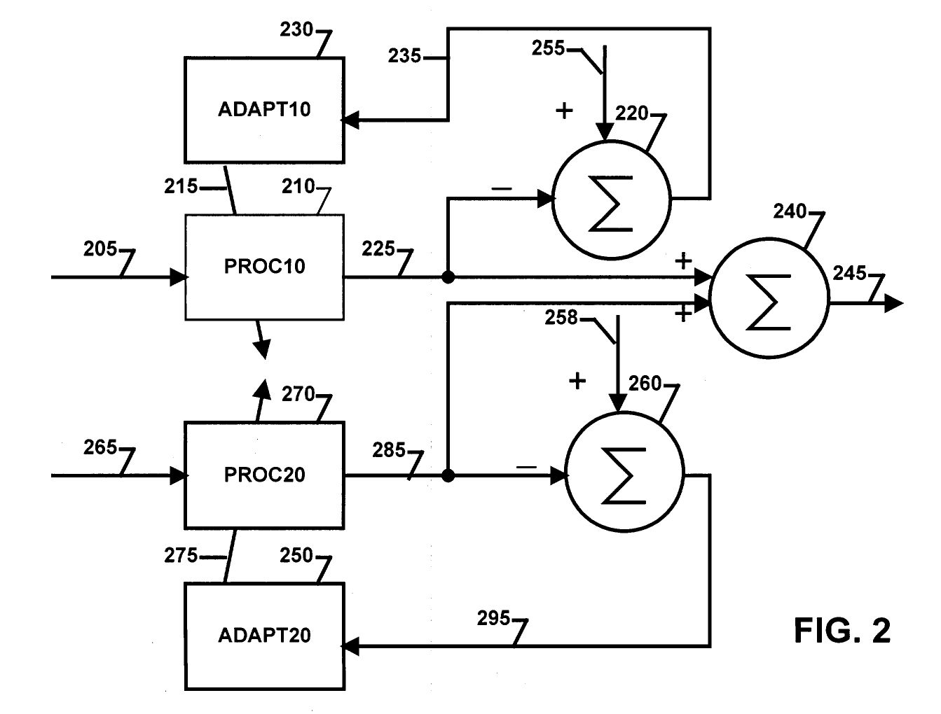

FIG. 2 depicts how the present invention could be applied to the previous case (FIG. 1 above). The first diversity input signal 205 is sent to PROC10 210 which produces partial estimate signal 225 output. The second diversity input signal 265 is sent to PROC20 270 which produces partial estimate signal 285 output. These partial estimate signals 225 and 285 are added together within summer 240 to produce the estimate signal 245 output.

Here is where the present invention deviates from the previous case. Partial estimate signal 225 is subtracted from desired signal 255 within summer 220 to produce an error signal 235 output. Error signal 235 is sent to ADAPT10 230 wherein an adaptation algorithm is applied to error signal 235 to produce adjustment group signals 215 (group herein refers to one adjustment signal per coefficient—in a some cases there may be only one coefficient to adjust). These adjustment group signals 215 are applied to PROC10 210 for coefficient weight adjustments. In like manner, partial estimate signal 285 is subtracted from desired signal 258 within summer 260 to produce an error signal 295 output. (It should be noted that desired signals 255 and 258 may be of the same value, but are not so constrained.) Error signal 295 is sent to ADAPT20 250 wherein an adaptation algorithm (e.g. LMS algorithm) is applied to error signal 295 to produce adjustment group signals 275. These adjustment group signals 275 are applied to PROC20 270 for coefficient weight adjustments. These error signals (235 and 295) are diversity related, thus the coefficient interactions between PROC10 210 and PROC20 270 are substantial reduced for most cases.

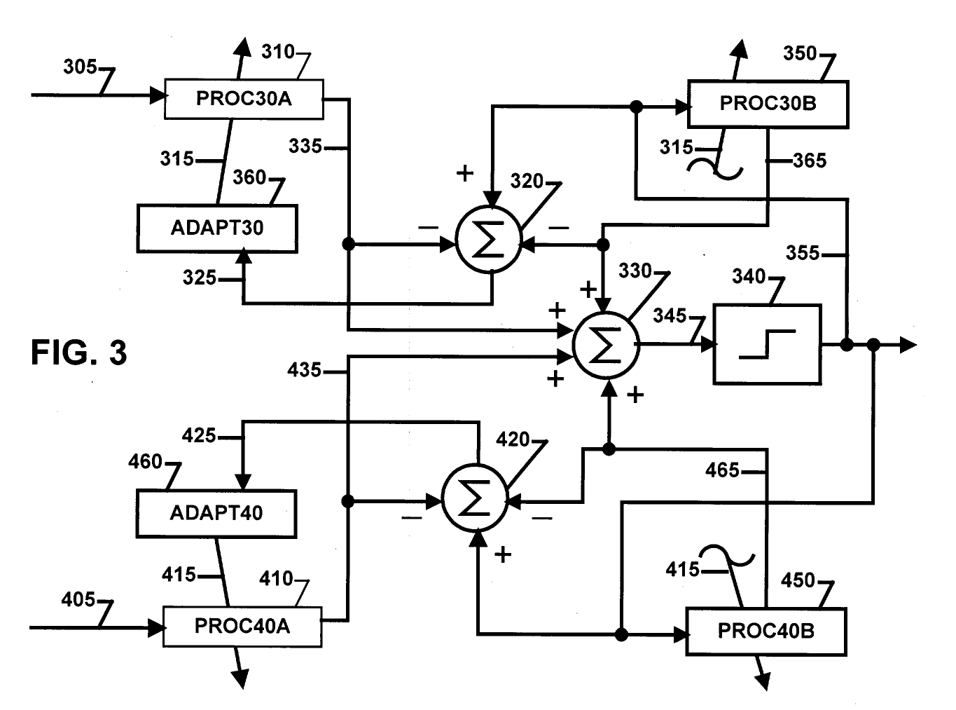

FIG. 3 depicts an alternate embodiment of the present invention. The first diversity input signal 305 is sent to PROC30A 310 which produces partial estimate signal 335 output. The second diversity input signal 405 is sent to PROC40A 410 which produces partial estimate signal 435 output. Partial estimate signals 335, 435, 365, and 465 are added together within summer 330 to produce the estimated data signal 345 output. This estimated data signal 345 is sent to a slicer 340. Slicer 340 makes the decision as to whether the estimated data signal is a logical ‘one’ or ‘zero’; then the slicer 340 outputs its decision signal 355 in the form of ideal data amplitudes that are quantized to represent ‘ones’ or ‘zeroes’. This decision signal 355 is sent to PROC30B 350 which produces partial estimate signal 365 output. Partial estimate signals 365 and 335 are subtracted from the quantized decision signal 355 within summer 320 to produce error signal 325 output. This error signal 325 is sent to ADAPT30 360 wherein an adaptation algorithm is applied to error signal 325 to produce adjustment group signals 315. These adjustment group signals 315 are applied to PROC30A 310 and PROC30B 350 for coefficient weight adjustments. Thus the loop is closed with the quantized decision 355 being the desired signal.

In like manner, decision signal 355 is sent to PROC40B 450 which produces partial estimate signal 465 output. Partial estimate signals 465 and 435 are subtracted from the quantized decision 355 within summer 420 to produce error signal 425 output. This error signal 425 is sent to ADAPT40 460 wherein an adaptation algorithm is applied to error signal 425 to produce adjustment group signals 415. These adjustment group signals 415 are applied to PROC40A 410 and PROC40B 450 for coefficient weight adjustments.

This embodiment (FIG. 3) could be implemented in digital, analog, or combinations thereof. However, it is preferred that the implementation be digital with the diversity input signals 305 and 405 being the digitized analog-to-digital (A/D) representation of the analog baseband signals; the processing delays would be obtained with digital registers as opposed to analog delays. An example of what we refer to as temporal diversity could be where diversity input signals 305 and 405 are derived from the same analog baseband signal. Diversity input signal 305 being derived from an A/D in synch with the data clock and the diversity input signal 405 being derived from an A/D that is clocked with the data clock offset by say half the period of the data clock.

What is claimed is:

1. Method for the adaptive signal processing for a plurality of signals comprising the steps of:
A) receiving a plurality of signals;
B) processing said plurality of signals within a plurality of respective input processors which have coefficient weights to produce a plurality of respective partial estimate signals;
C) adding said plurality of respective partial estimate signals to produce an estimate signal;
D) subtracting said plurality of partial estimate signals from a plurality of respective desired signals to produce a plurality of respective error signals;
E) processing said plurality of respective error signals with a plurality of respective adaptive algorithm processors to produce a plurality of respective adjustment group signals;
F) using said plurality of respective adjustment group signals to adjust the coefficient weights of said plurality of respective input processors.

2. Method for the adaptive signal processing for a plurality of signals comprising the steps of:
A) receiving a plurality of signals;
B) processing said plurality of signals within a plurality of respective input processors which have coefficient weights to produce a plurality of respective input partial estimate signals;
C) adding said plurality of respective input partial estimate signals with a plurality of respective decision directed partial estimate signals to produce an estimate signal;
D) quantizing said estimate signal to produce a decision signal;
E) processing said decision signal with a plurality of respective decision directed processors which have coefficient weights to produce said plurality of respective decision directed partial estimate signals;
F) subtracting said plurality of respective input partial estimate signals and said plurality of respective decision directed partial estimate signals from said decision signal to produce a plurality of respective error signals;
G) processing said plurality of respective error signals with a plurality of respective adaptive algorithm processors to produce a plurality of respective adjustment group signals;
H) using said plurality of respective adjustment group signals to adjust the coefficient weights of said plurality of respective input processors and said plurality of respective decision directed processors.
